(19) United States
(12) Patent Application Publication
(10) Pub. No.: US 2013/0036590 A1
(43) Pub. Date: Feb. 14, 2013

(54) HAND TOOL SEALING DEVICES AND METHODS

(71) Applicant: Mervyn Rudgley, Mission Viejo, CA (US)

(72) Inventor: Mervyn Rudgley, Mission Viejo, CA (US)

(21) Appl. No.: 13/637,179

(22) PCT Filed: Mar. 25, 2011
(86) PCT No.: PCT/US11/30003

§ 371 Date: Oct. 19, 2012

(30) Foreign Application Priority Data
Mar. 26, 2010 (US) 61318183

(51) Int. Cl. B23P 11/00; B23P 19/00

(52) U.S. Cl. 29/428; 29/700

(57) ABSTRACT

Devices and methods for sealing a workspace with a sealing device and a hand tool for operation on a fastener, including appropriate interfaces to isolate the workspace, for example, in preparation for utilization of an EDM device. The interchangeable and adaptable components are disclosed.

### RELATED APPLICATIONS

This application claims the full Paris Convention benefit of and priority to U.S. Provisional Patent Application Ser. No. 61/318,183, filed Mar. 26, 2010, the contents of which are incorporated by reference herein in its entirety, as if fully set forth herein. This application incorporates by reference U.S. application Ser. No. 12/603,507, filed Oct. 21, 2009, as if fully set forth herein.

### BACKGROUND

### Field

This disclosure relates to devices and methods for centered sealing of hand tools relative to a workpiece.

### SUMMARY

According to some exemplary implementations, disclosed is a hand tool sealing device, comprising: a base; an interface disposed at a bottom end of the base and configured to be sealably placed against a surface, including but not limited to a frame, containing a fastener; a reception configured to sealably receive at least a tip of a hand tool; wherein the base and the tip are configured to enclose a workspace when the interface is sealably placed against the surface and the tip is sealably received within the reception.

In some instances, a hand tool sealing device may include an outer gasket and an inner gasket attached to or forming said interface. In some instances a recess is provided at a bottom end of the base. The inner gasket may be at least part of an insert configured to fit within the recess. The recess may be generally concentric with said interface wherein the recess has an annular wall adjacent to the interface. In some instances an insert may be fitted into the recess. The insert providing a generally circular opening. In some instances the circular opening may be of a rigid material. In some instances at least a portion of the interface may be of a flexible, compressible material. The surface may be flat. The surface may be curved. The fastener may be a flat-head fastener having a surface flush with the surface.

According to some exemplary implementations, disclosed is a method of enclosing a workspace, comprising: providing a sealing device to a surface containing a fastener, whereby an interface of the sealing device is sealably placed against the surface; engaging a tip of a hand tool into a reception of the sealing device, whereby the tip is sealably engaged within the reception.

The workspace may be defined by at least the fastener, the surface, the interface, and the tip of the hand tool. The method may further comprise eroding at least a portion of the fastener. The method may further comprise flushing fluid through the workspace. The fluid may be a dielectric liquid. The method may further comprise maintaining the fluid in the workspace at a pressure higher than the pressure outside the workspace. The method may further comprise maintaining the fluid in the workspace at a pressure higher than atmospheric pressure.

### DRAWINGS

The above-mentioned features and objects of the present disclosure will become more apparent with reference to the following description taken in conjunction with the accompanying drawings wherein like reference numerals denote like elements and in which:

FIG. 1A shows a plan view of a base;

FIG. 1B shows a sectional view of a base;

FIG. 1C shows a perspective view of a base;

FIG. 1D shows a perspective view of a base;

FIG. 1E shows a top view of a base;

FIG. 1F shows a bottom view of a base;

FIG. 2A shows a sectional view of an insert approaching a base;

FIG. 2B shows a sectional view of an insert within a base;

FIG. 3A shows a plan view of a base with an insert;

FIG. 3B shows a sectional view of a base with an insert;

FIG. 3C shows a perspective view of a base with an insert;

FIG. 3D shows a perspective view of a base with an insert;

FIG. 3E shows a top view of a base with an insert;

FIG. 3F shows a bottom view of a base with an insert;

FIG. 4A shows a sectional view of an insert approaching a base;

FIG. 4B shows a sectional view of an insert within a base;

FIG. 5A shows a plan view of a viewer approaching a base;

FIG. 5B shows a sectional view of a viewer approaching a base;

FIG. 5C shows a perspective view of a viewer approaching a base;

FIG. 5D shows a perspective view of a viewer approaching a base;

FIG. 5E shows a top view of a viewer approaching a base;

FIG. 5F shows a bottom view of a viewer approaching a base;

FIG. 6A shows a plan view of a viewer within a base;

FIG. 6B shows a sectional view of a viewer within a base;

FIG. 6C shows a perspective view of a viewer within a base;

FIG. 6D shows a perspective view of a viewer within a base;

FIG. 6E shows a top view of a viewer within a base;

FIG. 6F shows a bottom view of a viewer within a base;

FIG. 7A shows a sectional view of a tip approaching a base; and

FIG. 7B shows a sectional view of a tip within a base.

### DETAILED DESCRIPTION

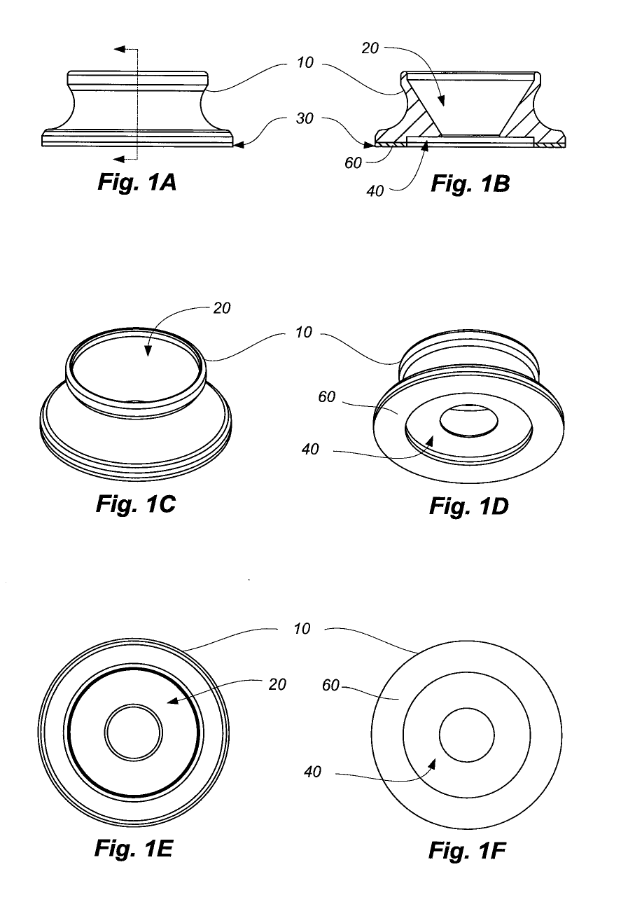

According to some exemplary implementations, hand tool sealing devices and methods are disclosed herein. According to some exemplary implementations, base 10 may be provided, as shown in FIGS. 1A, 1B, 1C, 1D, 1E, and 1F.

According to some exemplary implementations, base 10 may include interface 30. Interface 30 may be disposed at a bottom end of base 10. Interface 30 may be configured to be sealably placed against frame 410 with a surface 412 containing fastener 400.Said sealing being temporary and reversible.

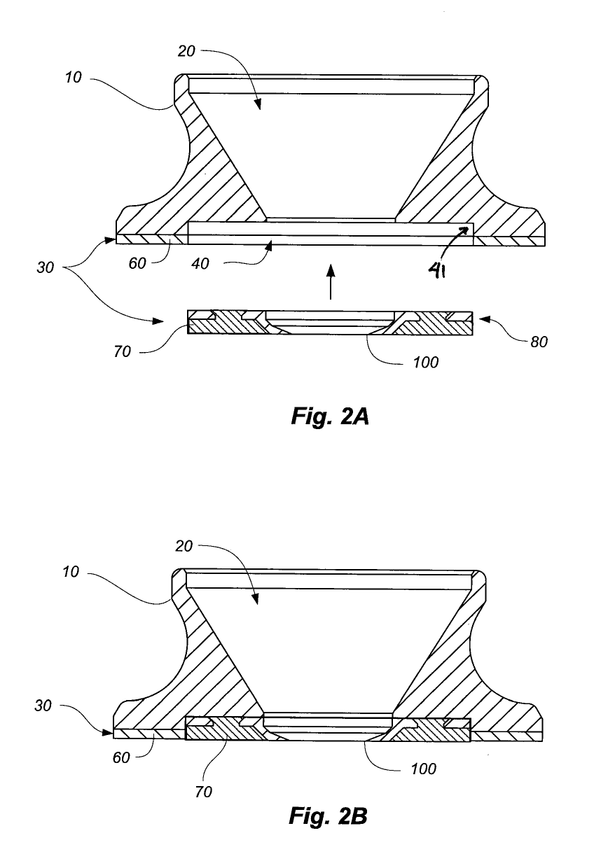

According to some exemplary implementations, interface 30 may include one or more constituent parts. For example, as shown in FIGS. 1B, 1D, and 1F, interface 30 may include outer gasket 60. Outer gasket 60 may be flexible and configured to form a seal when placed against a surface. As further shown in FIGS. 1B, 1D, and 1F, gasket 60 may be interrupted by recess 40 bounded by an annular wall 41. According to some exemplary implementations, interface 30 may include at least a portion of insert 80, as shown in FIGS. 2A and 2B.

According to some exemplary implementations, insert 80 may be selectably provided to recess 40 of base 10. Insert 80 may contain a variety of features selectably provided to achieve results tailored to circumstances and scenarios.

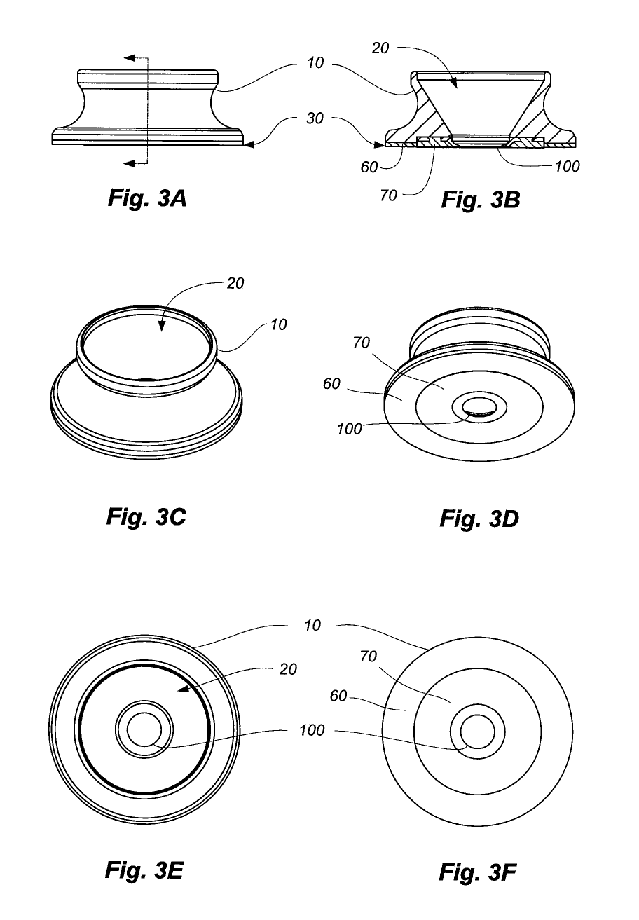

According to some exemplary implementations, as shown in FIGS. 2A, 2B, 3A, 3B, 3C, 3D, 3E, and 3F, insert 80 may include sight guide 100, which may be configured to assist a user in visually aligning base 10 or components thereof with fastener 400. Sight guide 100 may be any variety of shapes or sizes. Sight guide 100 may be of a rigid material to reduce or eliminate deformation that might interfere with accurate alignment based on sight guide 100.

According to some exemplary implementations, as shown in FIGS. 2A, 2B, 3A, 3B, 3C, 3D, 3E, and 3F, insert 80 may include inner gasket 70. Inner gasket 70 may form a portion of interface 30. Inner gasket 70 may be flexible and configured to form a seal when placed against a surface.

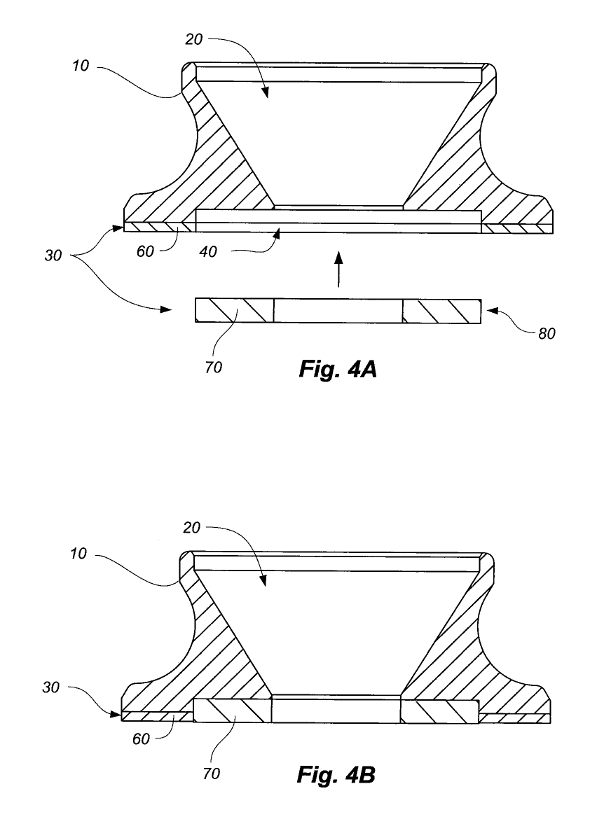

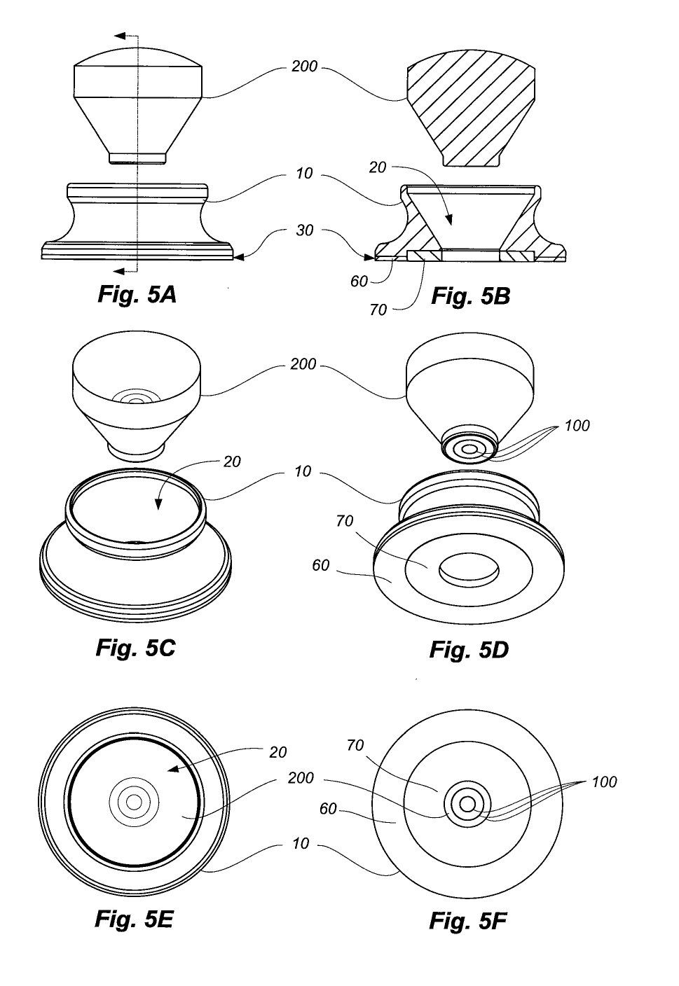

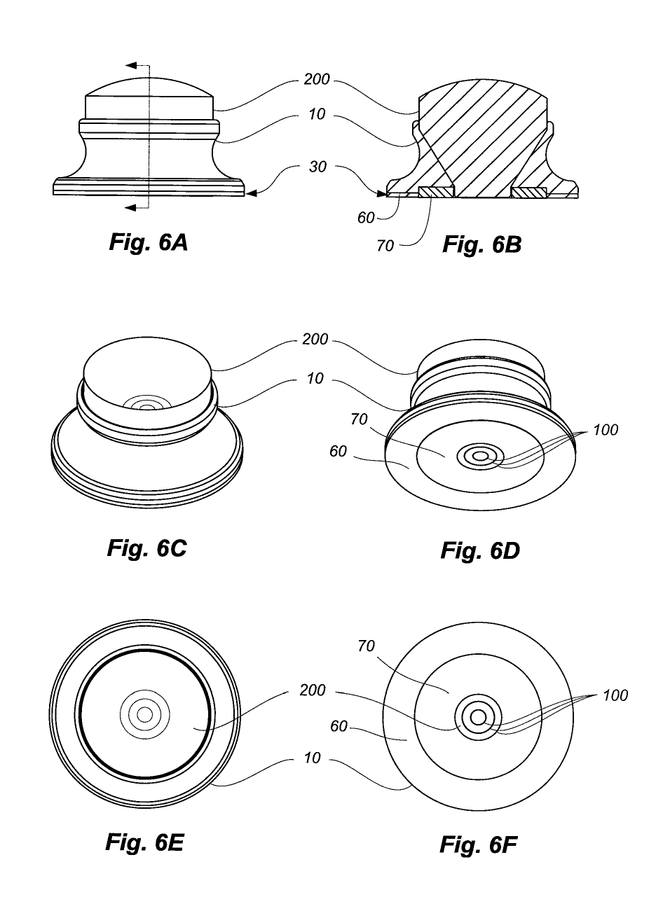

According to some exemplary implementations, as shown in FIGS. 4A and 4B, insert 80 may include inner gasket 70. As shown in FIGS. 4A and 4B, insert 80 may omit sight guide 100 of a rigid material. As shown in FIGS. 5A, 5B, 5C, 5D, 5E, 5F, 6A, 6B, 6C, 6D, 6E, and 6F, insert 80 may be configured to accommodate another device or component, such as viewer 200. As shown in FIGS. 5D, 5F, 6D, and 6F, viewer 200 may include sight guide 100.

According to some exemplary implementations, interface 30 may include at least one of outer gasket 60 and inner gasket 70. Interface 30 may provide features of sealing and stability as determined to be desirable by given applications. For example, interface 30 may provide durability, softness, pliability, friction, lubricity, and wiggle-resistance. Interface may be soft enough to hold a seal against a surface, yet rigid enough to not move undesirably. The seal may be held even when workspace 90 is in a high-pressure state.

According to some exemplary implementations, interface 30 may be compressible, wherein interface 300 provides a degree of cushioning at least in a longitudinal direction (at least substantially orthogonal to surface 412 to which interface 30 is applied). Compressibility of interface 30 provides a degree of adaptability for varying conditions and geometries of surface 412. According to some exemplary implementations, interface 30 may have limited longitudinal compression to keep the depth cut correct. For example, wide variation of position of base 10 relative to fastener 400 due to longitudinal compression of interface 30 may reduce accuracy of cut depth where depth is measured in reliance on at least an initial position of base 10.

According to some exemplary implementations, interface 30 may introduce reduced, minimal, or no lateral lash or play. For example, interface 30 may be configured to resist lateral compression that would cause base 10 to move laterally from an initial position.

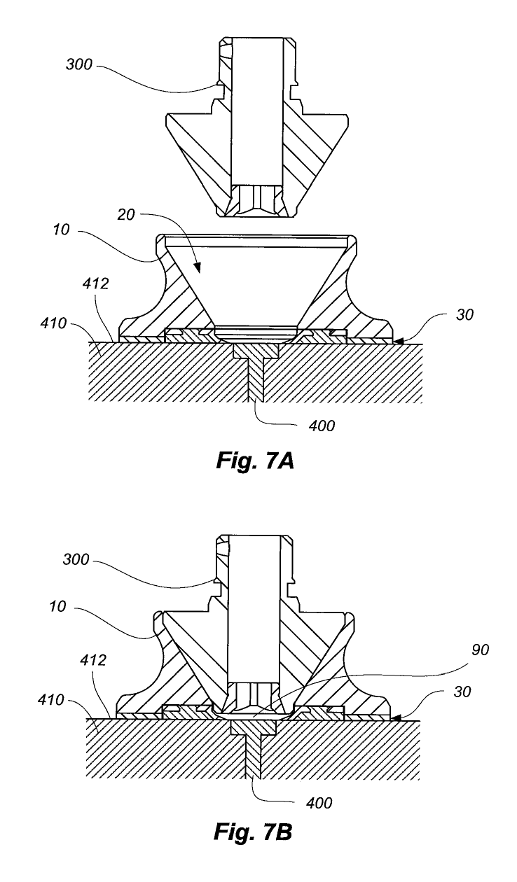

According to some exemplary implementations, base 10 may include reception 20. Reception 20 may expose a bottom end of base 10 to a top portion thereof. Reception 20 may be configured to sealably receive at least an erosion tip 300 of a hand tool. Said erosion tip in this exemplary implementation is, includes, or houses a plasma generating electrode. Electro-discharge devices, systems, and methods as disclosed in U.S. application Ser. No. 12/603,507, filed Oct. 21, 2009, may be applied, wherein a plasma is generated in conjunction with a dielectric to erode and/or disintegrate boluses of material in a controlled fashion. As shown in FIGS. 7A and 7B, tip 300 may be brought to reception 20 of base 10, which is placed on surface 412 of frame 410 and in a desired alignment relative to fastener 400. Tip 300 may be sealably placed within reception 20, such that workspace 90 is enclosed. The geometry of reception 20 and tip 300 may be complementary, such that the mating thereof forms a seal there between. The seal may be complete or substantial, according to some exemplary implementations.

According to some exemplary implementations, workspace 90 may be defined by one or more of at least fastener 400, surface 412, interface 30, outer gasket 60, inner gasket 70, sight guide 10, base 10, reception 20, and tip 300. Workspace 90 may be formed by the placement of base 10 relative to surface 412 and the placement of tip 300 relative to base 10. According to some exemplary implementations, workspace 90 may be enclosed by the seals formed, as disclosed herein.

According to some exemplary implementations, the hand tool may be used while tip 300 is engaged within reception 20. For example, at least a portion of fastener 400 may be eroded with the hand tool. According to some exemplary implementations, the hand tool may be any device configured to operate on fastener 400. According to some exemplary implementations, the hand tool may be an EDM device. The EDM device may be used to erode at least a portion of fastener 400. Such erosion may benefit from enclosed workspace 90 as disclosed herein.

According to some exemplary implementations, workspace 90 may be substantially or entirely air-tight. For example, sealed components and interfaces may allow workspace 90 to be separated from ambient air from outside workspace 90. Reduction or elimination of air in workspace 90 may reduce or avoid wear on an electrode of an EDM device, as well as undesirable welding, heat, damage, and burning.

According to some exemplary implementations, dielectric fluid may be provided to workspace 90. An inlet and outlet may flow the dielectric fluid through workspace 90, for example, through a space between an erosion electrode of an EDM device and a workpiece to be eroded (fastener 400, etc.). According to some exemplary implementations, dielectric fluid may be provided and maintained at a pressure within workspace 90 that is higher than the pressure outside workspace 90. For example, while the pressure within workspace 90 is high relative to the pressure outside workspace 90, the tendency of materials outside workspace 90 to enter workspace 90 is reduced or eliminated. By further example, inadvertent introduction of air from the ambient atmosphere outside workspace 90 may be avoided by maintaining sufficiently high pressure within workspace 90. The dielectric fluid may be a dielectric liquid, such as deionized water.

According to some exemplary implementations, interface 30 may be configured to be placed against surface 412 of frame 410 containing fastener 400. Interface 30 may be configured to conform to a known or determinable contour of surface 412 of frame 410. For example, interface 30 may be at least substantially flat to engage a flat surface 412. By further example, interface 30 may be curved to engage a curved surface 412. Other contours, shapes, morphologies, etc. are contemplated, with interface 30 or components thereof being adaptable, interchangeable to accommodate a given surface 412.

According to some exemplary implementations, fastener 400 may be any variety of fastener, object, or material to be acted upon. According to some exemplary implementations, fastener 400 may be a flat-head (non-protruding) fastener, such that little or no structure is available as a reference for centering of a hand tool, as shown in FIGS. 7A and 7B.

While the method and apparatus have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A hand tool sealing device, comprising:
a base;
an interface disposed at a bottom end of the base and configured to be sealably placed against a surface containing a fastener; and,
a reception configured to sealably receive at least a tip of a hand tool;
wherein the base and the tip are configured to enclose a workspace when the interface is sealably placed against the surface and the tip is sealably received within the reception.

2. The hand tool sealing device of claim 1, further comprising: a recess at a bottom end of the base.

3. The hand tool sealing device of claim 2, wherein the interface comprises an outer gasket and an inner gasket.

4. The hand tool sealing device of claim 3, wherein the inner gasket is at least part of an insert configured to fit within the recess.

5. The hand tool sealing device of claim 4, wherein the insert further comprises a circular opening.

6. The hand tool sealing device of claim 5, wherein the circular opening is of a rigid material.

7. The hand tool sealing device of claim 1, wherein at least a portion of the interface is of a flexible, compressible material.

8. The hand tool sealing device of claim 1, wherein the surface is flat.

9. The hand tool sealing device of claim 1, wherein the surface is curved.

10. The hand tool sealing device of claim 1, wherein the fastener is a flat-head fastener having a surface flush with the surface.

11. The hand tool sealing device of claim 1, wherein the hand tool is an EDM device.

12. A method of enclosing a workspace, the method comprising:
providing a sealing device to a surface, whereby an interface of the sealing device is sealably placed against the surface; and,
engaging a tip of a hand tool into a reception of the sealing device, whereby the tip is sealably engaged within the reception.

13. The method of claim 12, whereby the workspace is defined by at least the surface, the interface, and the tip of the hand tool.

14. The method of claim 13, the method further comprising, eroding at least a portion of a fastener within the workspace.

15. The method of claim 12, the method further comprising, flushing fluid through the workspace.

16. The method of claim 15, wherein the fluid is a dielectric liquid.

17. The method of claim 15, the method further comprising, maintaining the fluid in the workspace at a pressure higher than the pressure outside the workspace.

18. The method of claim 15, the method further comprising, maintaining the fluid in the workspace at a pressure higher than atmospheric pressure.

19. A method of sealing a workspace, the method comprising:
reversibly sealing the interface of a base containing a reception which is open top to bottom to a surface;
sealably mating the tip of a hand held device within said reception; and,
forming a workspace whereby the workspace is defined by at least the surface, the reception, and the tip.

20. The method of claim 19, the method further comprising, flushing fluid through the workspace.

21. The method of claim 20, wherein the fluid is a dielectric liquid.

22. The method of claim 21, the method further comprising eroding a portion of a fastener within the workspace.
